(19) United States
(12) Patent Application Publication
(10) Pub. No.: US 2014/0316806 A1
(43) Pub. Date: Oct. 23, 2014

(54) SYSTEM AND METHOD FOR HYGIENIC INTERACTION WITH A POTENTIALLY HAZARDOUS HEALTHCARE ENVIRONMENT

(71) Applicant: Rajika L. Munasinghe, Troy, MI (US)

(72) Inventor: Rajika L. Munasinghe, Troy, MI (US)

(21) Appl. No.: 13/865,558

(22) Filed: Apr. 18, 2013

(51) Int. Cl. G06F 19/00

(52) U.S. Cl. CPC G06F 19/3418
USPC 705/3

(57) ABSTRACT

Disclosed herein is a portable power source and computing device (collectively herein “mobile subsystem”) that accompany a healthcare professional as he or she treats or examines a patient before moving to another patient in another room. The mobile subsystem provides an interface to a receiving docking device (“stationary subsystem”) located at or near a relatively immobile site of healthcare delivery so that access can be afforded to an electronic medical records system for updating and observation. The disclosure includes a system and method for clinicians to access protected health information from an electronic medical record at different locations with a mobile subsystem that reduces risk of transmitting infection and reduces the need for repeated authentication for secure access.

### TECHNICAL FIELD

This disclosure relates to a system and method for hygienic and secure interaction between a health care provider and a potentially hazardous healthcare environment.

### BACKGROUND OF THE INVENTION

Healthcare provider interactions with patients can be one of the most important aspects of medical care. Interacting with the patient provides the best opportunity for the physician to both communicate and receive information that is used to provide medical care. For example, during a physician consultation, the patient and physician exchange a large amount of information concerning the visit. For the physician, this amounts to details concerning the background of illness, patient history, and family members with similar problems. The patient in turn, becomes educated about his or her illness, and is presented options to tackle the problem along with various risks and side effects with each treatment option.

Health care delivery is increasingly dependent on health care providers using computers, electronic medical record systems, electronic health record systems, medical imaging systems, patient registries, administrative databases and clinical reference resources to provide patient care in the era of information technology. Computers that connect to large remote database servers and smaller local servers using secure networks are now the standard across the world. Health care providers use a variety of devices to interact with these software utilities, including but not limited to desktop computers, laptop computers, ultraportable computers, tablet devices and smartphones. In order to ensure the necessary confidentiality of protected health information a variety of security features and protocols including multiple secure logons, secure remote desktop utilities, biometric and secure card logon access have been implemented. Patient identification using new electronic authentication systems such as barcode scanners, RFID technology and other point of service patient identification protocols are also being implemented to reduce medical errors and improve patient safety.

Using such secure, error free patient identification systems, interaction with health care databases and software utilities is being increasingly performed right at the point of service such as at the bedside or in procedure rooms in hospitals or surgical centers, at the examination rooms in ambulatory clinics and in patient homes by visiting physicians, nurses and other providers such as physical therapists. Such environments may be made more challenging when there may be a risk of spreading unwanted pathogens between rooms, equipment, healthcare workers or equipment.

Given the large amount of information that is communicated between the physician and the patient, personal computing devices are often used in both the communication and recording of information regarding the interaction. For example, the physician will usually create a record of the patient's concerns and a description of his or her symptoms. The record can be created during the interaction or afterward, relying on the physician's memory or handwritten notes.

Further, physicians often use computer monitors or other displays to communicate information to the patient. The physician can use a computer to display an educational video, information graphics, X-rays, test results, etc. The physician often displays this information as a tool in helping the patient understand his or her condition and to reduce any related anxiety.

There are several challenges to using computer devices at the point of service. Patient confidentiality and security of the electronic medical record must be maintained at all times and access has to be strictly limited to authorized individuals. Portability is an important consideration when providers have to move from one patient to another. Under conventional practices, when a provider moves to a new location he either has to carry the computer device with him or repeat the authentication step(s) to access the secure network at the new location using another device.

The option of carrying the device from location to location has become more attractive with the introduction of lightweight, ultraportable touchscreen devices such as tablets with long battery life. However touchscreen interfaces still do not have the same ease of use as standard keyboard, mouse and display monitors. In addition, contamination of the devices poses a risk from the standpoint of infection control. In addition to hand washing, non-destructive disinfection of electronic devices is also necessary to reduce transmission of infections from one patient to another.

As a result of these constraints, point of care access to health care information systems is still limited. Many institutions provide access at desktop stations with a large bank of desktop computers usually at nursing stations, physician offices or other dedicated locations.

Maintaining a large number of individual computing units at point of service locations is expensive, could pose a security risk and requires the organization to maintain inventories of a large number of computer devices.

As a result of these constraints, point of care access to health care information systems is still limited. Many institutions provide access at desktop stations with a large bank of desktop computers usually at nursing stations, physician offices or other dedicated locations.

One publication (2012/0253851) discloses a system for controlling and displaying medical records on a display. That reference describes a means of displaying all or selected portions of the information displayed on the primary screen of the physician/clinician device (computer/tablet/phone) on to a secondary display that is connected to a network using an electronic network authentication protocol to improve the interaction between the clinician and the patient. Access to the secondary display is provided by a network which may or may not be secure and immune from HIPPA concerns.

### SUMMARY OF INVENTION

In the healthcare environment of this disclosure's intended use it would be desirable to use a mobile subsystem that accompanies the healthcare provider to connect to a stationary subsystem located in a room (or nearby thereto, collectively referred to herein as “in-room”) with a primary display using a readily connectable and previously disinfected, secure hardwired physical connector instead of a network so that no activation key is needed when the healthcare provider moves sanitarily on to the next patient in the next room.

It would also be desirable to allow the clinician to access the stationary subsystem with a clean, full size keyboard and pointing device (e.g., a mouse or trackpad) to facilitate data entry and manipulation, plus other peripherals if needed (e.g., a barcode scanner, RFID, camera, as non-limiting examples).

Further, it would be desirable to restore the electrical charge associated with the mobile subsystem when connected to the in-room peripherals of the stationary subsystem, thereby prolonging the time the clinicians can use their devices when powered by the portable battery.

In broad terms, disclosed herein is a portable power source and computing device (collectively herein “mobile subsystem”) that accompany a healthcare professional as he or she (collectively herein “he”) treats or examines a patient before moving between rooms. The mobile subsystem provides an interface to a receiving docking device (“stationary subsystem”) located at or near a relatively immobile site of healthcare delivery so that access can be afforded to an electronic medical records system for updating and observation. The disclosure offers a system and method for clinicians to access protected health information from an electronic medical record at different locations with a mobile subsystem that reduces risk of transmitting infection and reduces the need for repeated authentication for secure access.

The computer device of the mobile subsystem disclosed herein does not require an integrated primary display or keyboard. One embodiment of the invention contemplates a mobile subsystem including a portable, wearable device without a primary display, keyboard or pointing device in order to reduce its size, thus also reducing power requirements substantially.

### BRIEF DESCRIPTION OF THE DRAWINGS

FIG. 1 illustrates a first embodiment of the disclosed system;

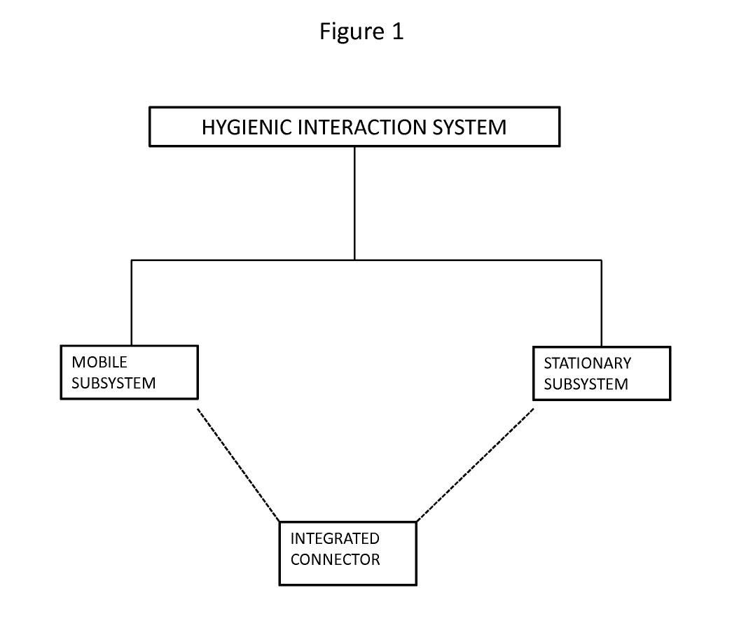

FIG. 2 illustrates some components of a mobile subsystem;

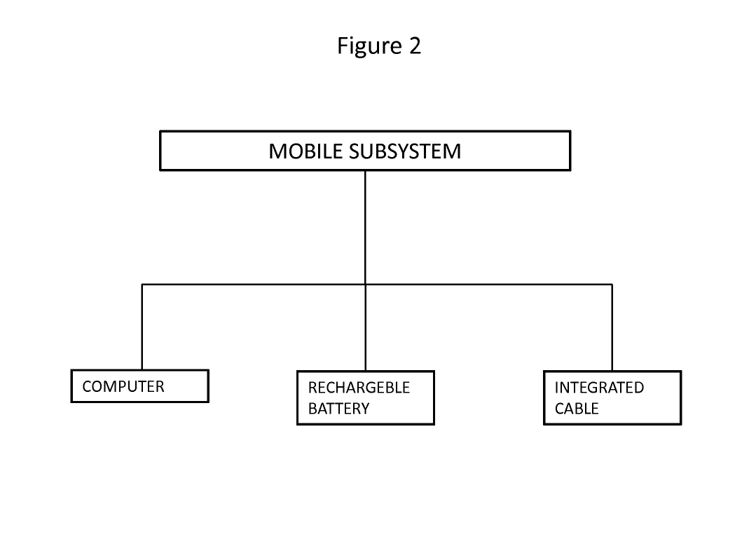

FIG. 3 illustrates some components of a stationary subsystem.

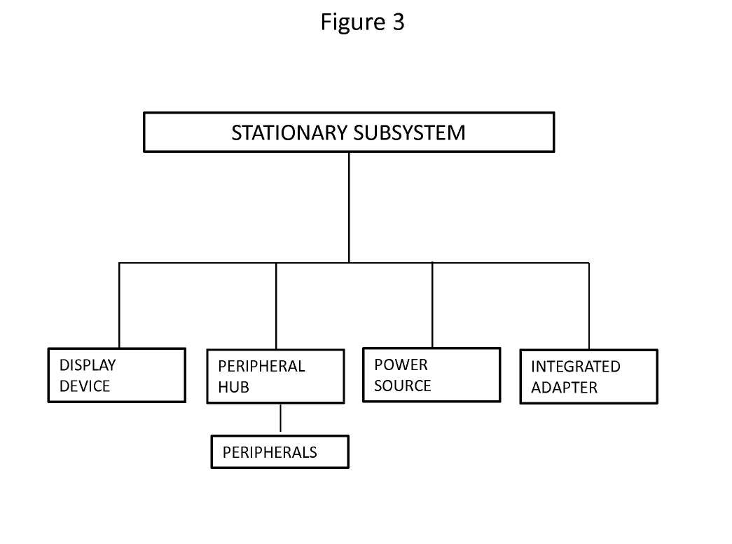

FIG. 4 illustrates connectivity of various parts of a hygienic interaction system; and

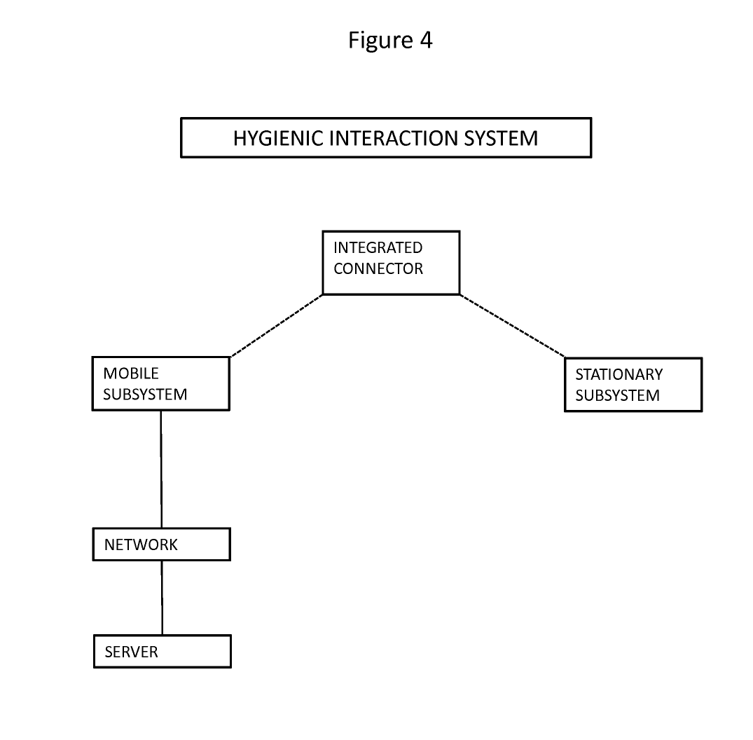

FIG. 5 depicts various optional process steps that need not be followed in the sequence shown.

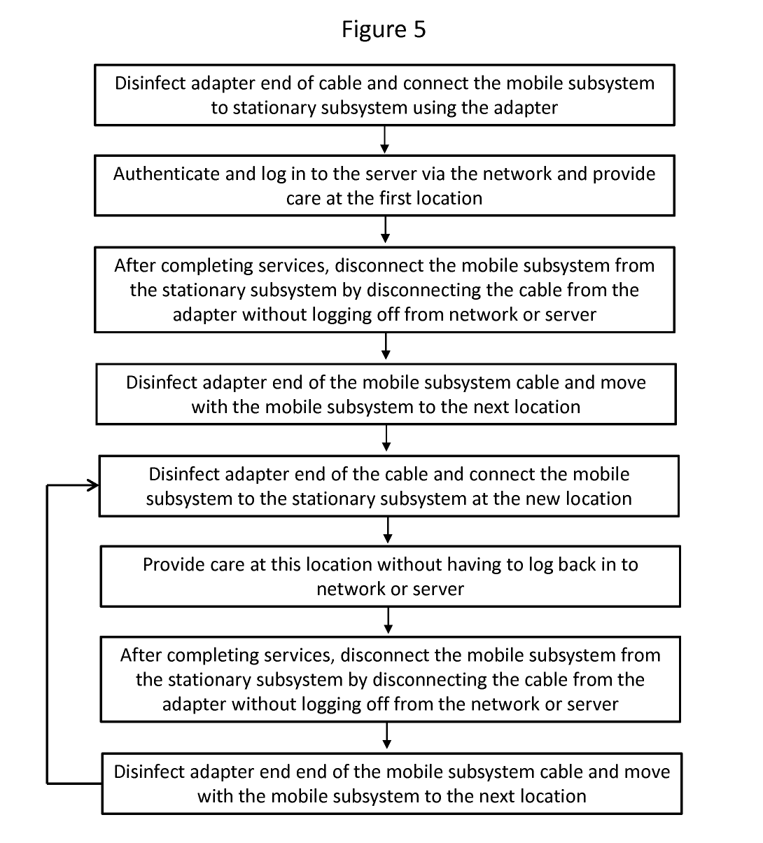

### DETAILED DESCRIPTION OF THE INVENTION

In one embodiment for use in the healthcare industry is a system and method that use a mobile subsystem with a low power, lightweight, small form factor, thin client (preferably wireless) computing device. It has a portable rechargeable battery pack that can be easily connected to and disconnected from a stationary subsystem that includes in-room standard peripheral components such as display devices, pointing devices and keyboards. An integrated connector allows health care providers such as physicians, nurses, patient care assistants, physical therapists, pharmacists and administrators (collectively herein, “healthcare provider”) to move from one location to another without losing connectivity to a server-based, secure electronic medical record or other software utility needed to provide patient care and avoids the need to log in each time the healthcare provider moves from one location to another.

Optionally, the computer device of the mobile subsystem can be carried in a pocket, waist belt or holster. This frees up the hands for other tasks such as examining the patient, taking notes or providing other necessary aspects of patient care.

The disclosed system maintains the confidentiality of patient information and data security. This is because the components of the system that contain the CPU and memory can be moved from one site to another when the user moves without losing connection with the server.

This arrangement allows the user to interact with the server-based software utilities using in-room display devices of any size and a standard full size keyboard and pointing device to maximize ease of use and work efficiency.

Any exposed components are small and can be thoroughly and easily disinfected. Sterilized components of the disclosed device and system minimize the risk of transmitting infectious agents from one person to another.

Low cost disposable keyboards and pointing devices can be used when highly contagious infectious agents that are difficult to disinfect are a consideration.

In one aspect, the disclosed system and method enable the healthcare provider to connect and disconnect from a network server or cloud server without having to log on and log off and renew credentials when moving between locations and from one set of peripheral devices such as keyboard, pointing device and display device to another. This solution facilitates easy cleaning and disinfection of a small form factor connector in settings that are not limited to healthcare where infection control is important while maintaining data security when the healthcare provider moves from one location to another.

Thus, the disclosed system and method contemplates a stationary subsystem with a dedicated device at each point of service to which the health care provider can connect access with a mobile subsystem including a portable power pack and a thin processor once upon entering a multi-room facility with a secure authentication protocol using passwords, keyfobs or biometric logon. This avoids the need to log on at each room repeatedly, thus impeding efficient work flow. Conventional approaches risk patient confidentiality if the provider forgets to logoff when leaving the side of the patient.

The disclosed system and method offer a way to overcome the difficulties of conventional practices with a unique low cost solution that uses small, low power, ultra-portable computer devices that are worn as opposed to being wheeled or carried by the health care provider. These devices use for example a small portable 5 volt lithium ion battery pack and operate using a compact low resource open source operating system such as Linux or Android. The devices are constantly connected to a secure wireless network using standard secure wireless protocols such as WiFi or cellular networks and secure thin client utilities such as a remote desktop and a Citrix receiver. Devices can also be deployed that operate on Microsoft, Apple or other proprietary operating systems.

Thus, the unique solution disclosed includes an interface of a mobile subsystem with a stationary subsystem. The mobile subsystem has a portable quick connecter that is preferably an integrated HDMI, USB. DisplayPort, Thunderbolt (or similar) and an adapter. Interfacing with the mobile subsystem is a stationary subsystem with an in-room housed dedicated set of peripherals such as a keyboard, pointing device, display device or other USB based peripheral device such as card reader, memory card reader/writer, RFID, barcode scanner, camera, printer or clinical measurement instrument such as automated vital sign measurement device, electronic stethoscope, or communication device.

A variety of carrying systems is contemplated for the healthcare provider to wear the computer-power pack unit including shoulder holsters, carrying belts (or holster) or custom designed pockets for lab coats and surgical scrubs.

As a non-limiting example, the other end of the cable has an integrated modular female or male HDMI, USB, DisplayPort, Thunderbolt (or similar) and 5V power connector that connects to the adapter. The initial connection type is an integrated modular single plug-in type. However a quick connect magnetic connector can be used in the alternative. This end of the cable is manufactured using disinfectant resistant modular plastic and can be wiped down with a single disinfectant wipe at the end of use. Optionally, a plastic clip (or similar device) is integrated to this end so that it can be clipped (or otherwise attached) on to a lab coat pocket or other part of clothing when moving from one location to another.

The adapter connects the cable to the in-room peripherals. One side has an integrated modular female or male HDMI, USB, DisplayPort, Thunderbolt (or similar connectors) and 5V adapter to easily and quickly connect to the cable. The other side has female or male HDMI, USB, DisplayPort, Thunderbolt (or similar connectors) and 5V power connector that can be custom wired to the HDMI (display) port of the display device, a standard powered USB hub and 5V power unit. The power adapter can draw power off the powered hub or directly off the power unit of the USB adapter using a splitter. Based on the needs and preferences of the individual service provider, the USB hub is able to accommodate a number of peripherals such as barcode scanners, RFID receivers and magnetic card readers in addition to the keyboard and pointing device. In-room keyboards and pointing devices could be scrubbed down and disinfected when the patient leaves that particular location.

When the healthcare provider arrives at the point of service, he would wipe down and disinfect the end of the cable and connect it to the adapter. This allows him to immediately connect to the information system without authentication and continue working from where he left off the last time. The cable would have sufficient slack to permit the provider to examine the patient and interact with the peripherals at the same time. If needed the provider can disconnect and reconnect to the adapter any number of times without having to log off.

The battery pack of the mobile subsystem preferably continues to charge when it is connected to the adapter, thereby extending the time the provider can use the unit when energized by a single charge of the battery pack. When point of care services are completed, the provider simply disconnects without logging off, disinfects the end of the cable, clips (or otherwise affixes) the end to clothing and moves to the next location.

Two other configurations are foreseeable alternative embodiments. The first is a docking device which will accommodate the computer battery pack without cables. It will have integrated HDMI, USB, DisplayPort, Thunderbolt (or similar connectors) and power connectors (e.g., 5 volt) to dock with similarly configured counterparts on the computer battery pack end. In this configuration the user will carry the computer-power pack device in a holster or pocket and simply take it out and dock it at the docking station. Both the docking station and the computer-power pack device will be configured such that they can be wiped down and disinfected when needed.

The second alternate configuration comprises an integrated computer-power pack and mouse (pointing) device. The three components would be miniaturized and configured in to one of two devices to meet user preferences. The first is an optical mouse and the second is a track pad. This combined device will connect with the adapter using a flexible cable that has integrated HDMI, USB, DisplayPort, Thunderbolt (or similar connectors) and 5V power wires and connectors.

A variety of peripherals can be custom configured to unite with connectors for different locations. Standard display monitors, keyboards and mice can be configured at desks and nursing stations. Wall mounted units can be configured out on hallways and outside patient rooms. Point of service configurations could include configurations that are ergonomically designed to help the provider interact with the patient and the peripherals simultaneously in most optimal way for the particular situation. For example, peripherals can be integrated with examination tables, hospital beds, transportation gurneys, bedside tables and other situations.

It is also contemplated that adapters can connect with KVM switches which can manually or electronically switch from one computer unit to another. This will enable institutions to maintain fixed, hardwired units at specific locations but allows the peripherals attached to these units to be quickly switched over to a unit worn by a healthcare provider using the disclosed system and method.

The inventor also contemplates developing several portable configurations that use small form factor keyboards, track pads and display goggles to connect with devices. This will enable providers to interact with smaller portable unit configurations under special circumstances such as providing point of service care in a patient room but use more easy to use traditional set of peripherals

The method optionally makes use of a portable computer unit in the mobile subsystem such as the Raspberry Pi, Android Mini PC MK802, Beagle Bone or Cotton Candy and battery pack such as the Anker Astro 3E, EasyAcc 4 that connects to a standard size display of the stationary subsystem and set of peripherals such as a keyboard and computer mouse that remain at the point of service. This method uses an interface that consists of a quick integrated connecter that has a connector such as a HDMI connector or a Display Port connector for a display device, a connector such as a USB connector for the peripherals (keyboard and mouse) and a power connector to charge the battery pack.

Using a multi-port peripheral connector such as a USB hub, the peripherals connecting with the thin client computer device can be expanded to include devices such as magnetic card readers, memory card reader/writers, RFIDs, barcode scanners, cameras, communication devices, printers, and devices such as automated thermometers, blood pressure meters, electronic stethoscopes and cardiac monitors.

A cable and adapter device connects the computer with the power pack to the peripherals. One end of the cable has male or female connections for the display and peripheral ports on the computer device and an attachment to the charging port of the power supply. The other end has integrated display and peripheral connections in male or female configurations and a power port connector to connect with adapter. This end of the cable that connects to the adapter is specially configured as a single unit for easy connection and release from the adapter such as interlocking ends or magnetic connections. The end of the cable and connector is also configured such that it can be quickly wiped down and disinfected using disinfecting wipe. The other end of this adapter has connections for the display device and peripherals and a power adapter.

The connections at this end are configured to remain connected on a permanent basis and the attached peripherals are powered independently so that they do not draw power from the portable computing unit that connects via the adapter.

The computer and the power pack units of the mobile subsystem can be configured in ways such that they can be worn on shoulder holsters, carrying belts (or holsters) or within the pockets of lab coats and surgical scrubs. The cable preferably would have coiled or uncoiled configurations and come in different lengths to meet the variety of preferences of the care providers. This end of the cable is optionally manufactured using disinfectant resistant modular plastic and can be wiped down with a single disinfectant wipe after use. A clip or fastening device could be integrated to this end so that it can be clipped or otherwise attached on to a lab coat pocket or other part of clothing for ease of carrying when moving from one location to another.

When health care workers arrive at the point of service, they would wipe down and disinfect the adapter end of the integrated connector on the cable and then connect it to the adapter at the point of service. This will allow them to immediately connect to the information system without authentication and continue working from where they left off the last time. The cable would have sufficient slack to permit the provider to examine the patient and view the display and use the peripherals at the same time. If needed providers can disconnect and reconnect to the adapter any number of times without having to log off. The battery pack of the units continues to charge when it is connected to the adapter, thereby extending the time the provider can use the unit off of a single charge of the battery pack. When point of care services are completed, the provider simply disconnects the cable end connector from the adapter, disinfects this end of the connectors of the cable, clips or attaches the end to clothing and moves to the next location.

The thin client computer devices connected via the adapters can also be configured to connect with a keyboard, video, mouse switches that manually or electronically switch from one computer unit to another. This will enable institutions to maintain fixed, hardwired units at specific locations but allows the peripherals attached to these units to be quickly switched over to a thin client computer unit carried by a clinician.

One aspect of the disclosure includes design elements that reduce the size of the exposed parts to limit contamination and facilitate sterilization. No keyboard or display needs to be sterilized or sanitized when moving between patients because such peripherals stay in the room.

Preferably disinfectant-resistant materials are used to permit easier disinfection of the exposed parts of the clinician's device.

In an alternate embodiment the system includes a disposable sack or disposable cover into which the mobile subsystem can be inserted before entering a zone of contamination. In use, the mobile subsystem stays in the covering medium. After use, the mobile subsystem is removed therefrom and the sack is discarded.

Other features and advantages of the invention will become apparent to those skilled in the art upon review of the detailed description, claims and drawings in which like numerals are used to designate like features.

Various features of the invention are set forth in the following claims. It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

Certain terminology is used herein for purposes of reference only, and thus is not intended to be limiting. For example, terms such as “display device” refer to any computer system or display type for displaying received information. Terms such as program, interface, workstation are intended to provide contextual information for understanding the type of computing systems that may be used to implement the concepts described herein and are not intended to limit the present invention to specific hardware implementations. Such terminology may include the words specifically mentioned above, derivatives thereof, and words of similar import.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a server” and “a processor” can be understood to include one or more controllers or processors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network. It should be understood that a computer program may embrace constituent programs and that multiple programs may be implemented as a single or multiple programs.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications are hereby incorporated herein by reference in their entireties.

1. A system for hygienic interaction between a health care provider and a potentially hazardous healthcare environment, the system comprising:
a mobile subsystem with a low power, lightweight, computing device and a portable rechargeable battery pack;
a stationary subsystem to which the mobile subsystem can be connected and disconnected, the stationary subsystem having in-room peripheral components such as display devices, pointing devices, touch screens and keyboards, the stationary subsystem including
an integrated connector between the mobile and stationary subsystems that allows the health care provider to move from one location to another without losing connectivity to a server-based, electronic medical record or other software utility useful in providing patient care and avoids the need to log in each time the healthcare provider moves from one location to another.

2. The system of claim 1, wherein the computing device of the mobile subsystem can be carried in a pocket, waist belt or holster, thereby freeing up the hands for other tasks such as examining the patient, taking notes or providing other aspects of patient care.

3. The system of claim 1, further including a network with which the mobile subsystem is in communication as the healthcare provider moves from one location to another, while maintaining confidentiality of patient information.

4. The system of claim 3, further including software utilities with which the healthcare provider can interact using the stationary subsystem to maximize ease of use and work efficiency.

5. The system of claim 1, wherein the mobile subsystem, the stationary subsystem and the integrated connector have exposed components that can be thoroughly and easily disinfected so that the disinfected components may minimize the risk of transmitting infectious agents.

6. The system of claim 5, wherein the stationary subsystem has disposable keyboards and pointing devices for use when highly contagious infectious agents are or may be in places that are difficult to disinfect.

7. The system of claim 3, wherein the network enables the healthcare provider to connect and disconnect from peripherals without having to log on and log off from the server or network and renew credentials when moving between locations and from one stationary subsystem to another, thereby facilitating cleaning and disinfection.

8. The system of claim 7, wherein the health care provider can log-in with the mobile subsystem once upon entering a multi-room facility with a secure authentication protocol, thereby avoiding the need to log on at each room repeatedly, thus impeding efficient work flow and avoiding risk to patient confidentiality if the healthcare provider fails to logoff when leaving a patient.

9. The system of claim 1, wherein the portable subsystem has a rechargeable battery and the mobile subsystem operates using an operating system.

10. The system of claim 9, further including a secure wireless network to which the mobile subsystem is connected using a secure wireless protocol such as WiFi or a cellular network and a secure thin client utility.

11. The system of claim 1, wherein the mobile subsystem has a portable quick connecter that has an integrated HDMI, USB, DisplayPort, Thunderbolt or similar connector and an adapter.

12. The system of claim 11, wherein the stationary subsystem has an in-room housed set of peripherals selected from the group consisting of a keyboard, a pointing device, a display device, and other USB based peripheral devices such as card reader, memory card reader/writer, RFID, barcode scanner, camera, printer and a clinical measurement instrument such as an automated vital sign measurement device, electronic stethoscope, and communication device.

13. The system of claim 1, further including a carrying subsystem associated with the healthcare provider and the mobile subsystem, the carrying subsystem being selected from the group consisting of a shoulder holster, a belt clip, a pocket and a lapel clip.

14. The system of claim 1, wherein the portable computer unit in the mobile subsystem is selected from the group consisting of a Raspberry Pi, Android Mini PC MK802, BeagleBone, and Cotton Candy and comparable devices and the battery pack is selected from the group consisting of an Astro 3E, an EasyAcc 4 and comparable devices.

15. A method for using the system of claim 1, comprising the steps of:
disinfecting an adapter end of a cable to be connected to the integrated connector, thereby forming a disinfected end;
connecting the disinfected end to the connector at the point of service, thereby allowing the healthcare provider to connect to a network without authentication and thus resuming working.

16. The method of claim 15, further comprising the step of:
disconnecting from the stationary subsystem; and
disinfecting the adapter end of the cable before moving on to the next point of service so as to minimize the risk of unwanted pathogen transmittal.

17. The method of claim 15, further including the step of:
deploying a disposable cover into which the mobile subsystem is inserted before the healthcare provider enters a zone of contamination;
leaving the mobile subsystem in the cover while the mobile subsystem is in use; and
after use, removing the mobile subsystem from the cover; and
discarding the cover.
